(19) United States
(12) Patent Application Publication
(10) Pub. No.: US 2007/0159016 A1
(43) Pub. Date: Jul. 12, 2007

(54) Vibration generator and assemblies embodying same

(76) Inventor: Louis Olivier, Western Cape Province (ZA)

Correspondence Address: MEYERTONS, HOOD, KIVLIN, KOWERT & GOETZEL, P.C., P.O. BOX 398, AUSTIN, TX, 78767-0398, US

(21) Appl. No.: 10/588,296

(22) PCT Filed: Feb. 3, 2005
(86) PCT No.: PCT/IB05/00267

§ 371 Date: Aug. 3, 2006

(30) Foreign Application Priority Data
Feb. 4, 2004 (ZA) 2004/0901

(51) Int. Cl. H02K 7/06; H02K 21/00; H02K 19/00; H02K 1/12

(52) U.S. Cl. 310/81; 310/152; 310/254; 310/164

(57) ABSTRACT

A vibration generator (11) is provided that comprises a housing (1), a weight (3) that is movable relative to the housing in a manner operatively imparting a vibratory movement to the housing, and means for imparting movement to the weight in a manner causing said vibratory movement of the housing. The weight is in the form of a magnetic element that is freely movable along a track (2) that is typically endless formed within the housing. A plurality of electric coils (6) are associated with the track in a manner enabling sequential energisation of the coils to create movement of the magnetic element within the track in a manner imparting a vibratory movement to the vibration generator. Various composite units comprising two or more vibration generators are also described as well as a vibration generator assembly comprising at least two vibration generators or composite units connected to a common control unit (9).

### FIELD OF THE INVENTION

This invention relates to a vibration generator and assemblies embodying same and, more particularly, to a vibration generator that is useful in application to the human body by generating vibrations that are transferred to the body, typically by way of a cushion or mattress that may form part of an article of furniture such as a chair or bed.

### BACKGROUND TO THE INVENTION

It is well established that the application of vibrations of various different types to the human body, including activities often referred to as massage, has a highly beneficial effect that may vary according to how the vibrations are applied to the body, and the configuration of the vibration generator itself. The effect ranges from being substantially therapeutic to simply being relaxing with numerous side benefits, not least of which is relieving stress. There has, accordingly, being appreciable activity in designing different apparatus that may vary according to the ultimate objective.

Thus, U.S. Pat. No. 3,064,642, that dates back to 1957, proposes a dedicated massage table that had numerous vibration generators built into its so that the different regions of a person's body could be treated with vibrations. This table is extremely expensive and is totally inappropriate to domestic use.

U.S. Pat. No. 3,311,935 describes a vibration generator as applied to a child's cot.

Other apparatus based on vibration generators are used for a variety of purposes of this general nature some of which are described in U.S. Pat. Nos. 3,678,923; 3,811,430; 4,559,929; 4,570,616; 5,188,096; 5,437,608; 5,730,707; 6,056,357; 6,505,361; and, as a rather special apparatus, 6,668,399.

There is, accordingly, a need for vibration generators that can provide different and varied types of vibrations to suit different requirements and this need has been addressed in U.S. Pat. Nos. 4,570,616; 5,181,504; and 6,217,533, all of which strive to provide adjustable vibration generators that can be used to create various vibratory motions.

As a general rule, all of the prior art vibration generators operate, as far as applicant is aware, on a rotatable shaft or disc having an eccentric weight that creates a vibration as the shaft rotates. Vibration generators of this type in which the vibrations are adjustable have included two different motors, in all cases with generally horizontal axes of rotation, and in the latter case (namely U.S. Pat. No. 6,217,533) the axes of rotation being at generally right angles to each other in a horizontal plane. The latter also provides versatility in that the it provides for two vibration generators that are independently controlled by the single control unit and that can be positioned at any required place, for example on a mattress, cushion or the like

### OBJECT OF THE INVENTION

It is an object of this invention provide a vibration generator that provides a somewhat different type of vibratory movement and that can, at least in certain forms thereof, provide for considerable versatility and variation of the format of the vibratory movement.

### SUMMARY OF THE INVENTION

In accordance with one aspect of this invention there is provided a vibration generator comprising a housing, a weight that is movable relative to the housing in a manner operatively imparting a vibratory movement to the housing, and means for imparting movement to the weight in a manner causing said vibratory movement of the housing, the vibration generator being characterised in that the weight is in the form of a magnetic element that is freely movable along a track within the housing and in that a plurality of electric coils are associated with the track in a manner enabling sequential energisation of the coils to create movement of the magnetic element within the track in a manner imparting a vibratory movement to the vibration generator. Further features of the invention provide for the track to be an endless track, that typically follows a circular but optionally an elliptical path, in which case the coils are generally equally spaced around the periphery of the track; for the coils to be wound around the housing concentrically with the track therein at spaced positions along the length of the track; for the track to have a surface layer operatively engaged by the magnetic element, said surface layer having desirable qualities including that of sound absorption; for the magnetic element to be spherical in shape in which case the track is preferably of generally circular shape in cross-section; and for the housing and coils to be encased within an outer shell that may be cast or moulded in situ to permanently enclose the housing and coils.

Depending on the materials of manufacture it may be desirable to seal the housing in a closed condition following evacuation of air and optional purging with a suitable gas such as nitrogen or helium.

In accordance with a second aspect of the invention there is provided a vibration generator composite unit comprising a vibration generator as defined above together with a second vibration generator located coaxially therewith and wherein the two vibration generators are optionally independently controlled, or interdependently controlled, optionally utilizing a microprocessor to control energization of the coils of each of the two tracks independently or according to an interrelationship dictated by desired characteristics of vibrations created thereby. The two vibration generators are preferably of different diameters with the smaller being received within the larger in substantially coplanar relationship and the two are preferably releasably interconnected such as by clipping them together.

It will be understood that vibrations created utilizing a vibration generator or vibration generator composite unit as defined above are created in a plane that is generally parallel to the plane of the track. In the event that a transverse vibratory component is required, an auxiliary vibration generator having a reciprocally movable weight therein can be configured to locate in the centre of the vibration generator with the axis of movement of the weight being at generally right angles to the plane of the track. The reciprocally movable weight is, as in the case of the vibration generator itself, moved by alternating magnetic fields created by at least two electric coils that are energized alternately.

In accordance with a third aspect of the invention there is provided a vibration generator assembly comprising at least two vibration generators or vibration generator composite units as defined above connected to a common control unit that controls the operation of the various electric coils associated with the tracks of the various vibration generators.

Further features of this aspect of the invention provide for the various vibration generators to be controlled so that, when spaced apart on a common surface such as that of a mattress, for example, interference waves are created as the two sets of vibrations in generally the same plane impinge on each other.

It will be understood that the interference between the two sets of vibrations, and in the event that there are more vibration generators associated with the assembly, then all of the sets of vibrations, creates what may be considered to be standing waves and by adjustment of the vibration generators the location and severity of the standing waves can be adjusted.

It will therefore be appreciated that vibration generators according to this invention, and assemblies thereof, can be employed to create numerous different types of vibrations even to the extent of controlling the location of standing waves that are created by interference between two or more sets of vibrations. The invention therefore provides vibration generators and assemblies thereof that are highly versatile and can be configured to provide numerous different configurations of vibrations.

In order that the invention may be more fully understood one embodiment and various variations thereof will now be described with reference to the accompanying drawings.

### BRIEF DESCRIPTION OF THE DRAWINGS

In the drawings:—

FIG. 1 is a cross-sectional elevation of one form of housing defining a track therein for a freely movable spherical magnetic element;

FIG. 2 is a party broken away plan view thereof illustrating also an outer shell encasing the housing;

FIG. 3 illustrates, in plan view, one assembly of, in this case four, vibration generators according to the invention; and,

FIG. 4 is a schematic elevation illustrating the various parts of one vibration generator composite unit having three components.

### DETAILED DESCRIPTION WITH REFERENCE TO THE DRAWINGS

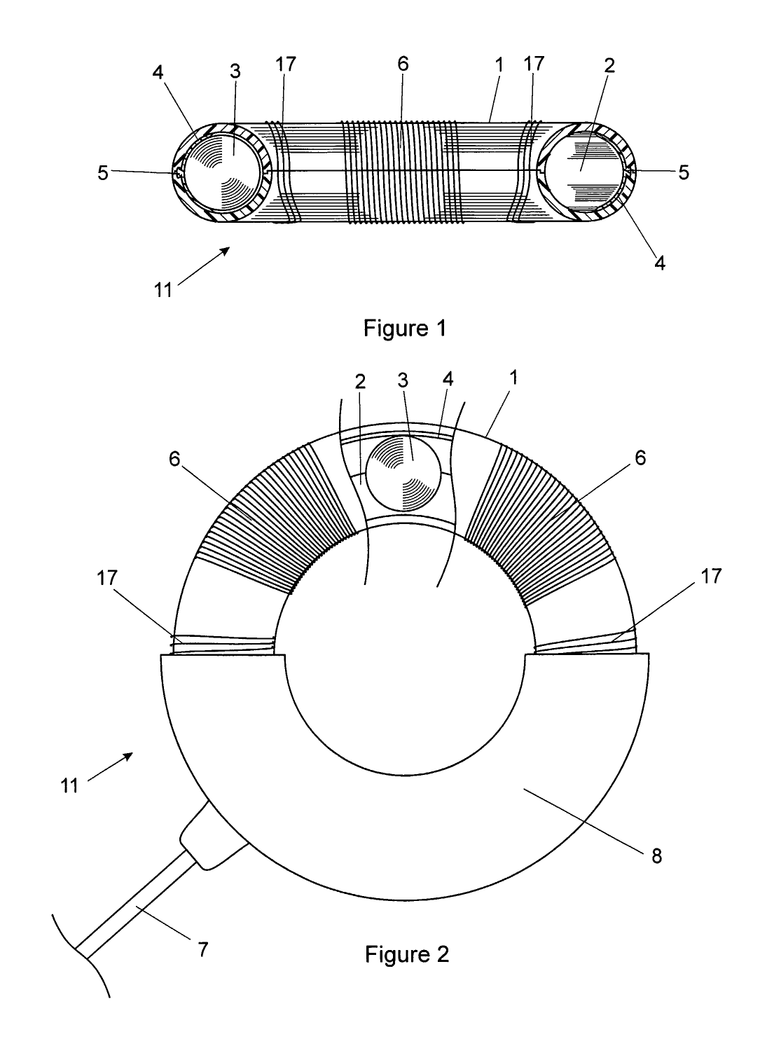

In the embodiment of the invention illustrated in FIGS. 1 and 2 a housing (1) is made of two injection moulded plastics parts secured together to define an endless circular track (2) of circular shape in cross-section or, to put it another way, of toroidal shape.

A magnetic element in the form of a spherical ball (3) is accommodated within the track, the diameter of the ball being somewhat less than the diameter of the track. The material from which the ball is made can be selected from a number of different materials and it is not yet clear as to whether or not eddy currents could be a significant factor to be taken into account when selecting the material. If so, the ball could be made from any laminated magnetic material, as in the case of transformers. If not the ball could be simply an iron or steel ball, or even one made of a suitable ferrite, for example.

A separately moulded insert (4) forms a layer on the circumferentially outer portion of the surface of the track for engagement by the ball as it rotates within the track, in use. This insert is made of a suitable material that has the effect of damping any sound that may be created by the ball engaging the surface of the track and of generally providing a smooth surface that the ball can engage, in operation. The insert can be anchored in position by means of an integral peripheral bead (5) that is clamped between the two parts of the housing at the time of assembly.

It is to be mentioned that, as appropriate, the track can be evacuated when sealing the housing in a closed condition and may also be purged with a suitable gas such as nitrogen or helium. Sealing of the housing in a closed condition can be achieved in any way, and the two parts of the housing could be sealed by means of O-rings encircling the inner and outer edges of the two parts, or they may simply be ultrasonically welded together.

A series, in this case four, electromagnetic coils (6) are wound around the outside of the housing and at equally angularly spaced positions, as shown in FIG. 2. The coils are individually connected to a control cable (7) so that they can be individually energized sequentially as provided by the invention.

Finally, the housing and associated coils are encased within an outer shell (8) that can be moulded or cast around it to encase and protect the coils and housing.

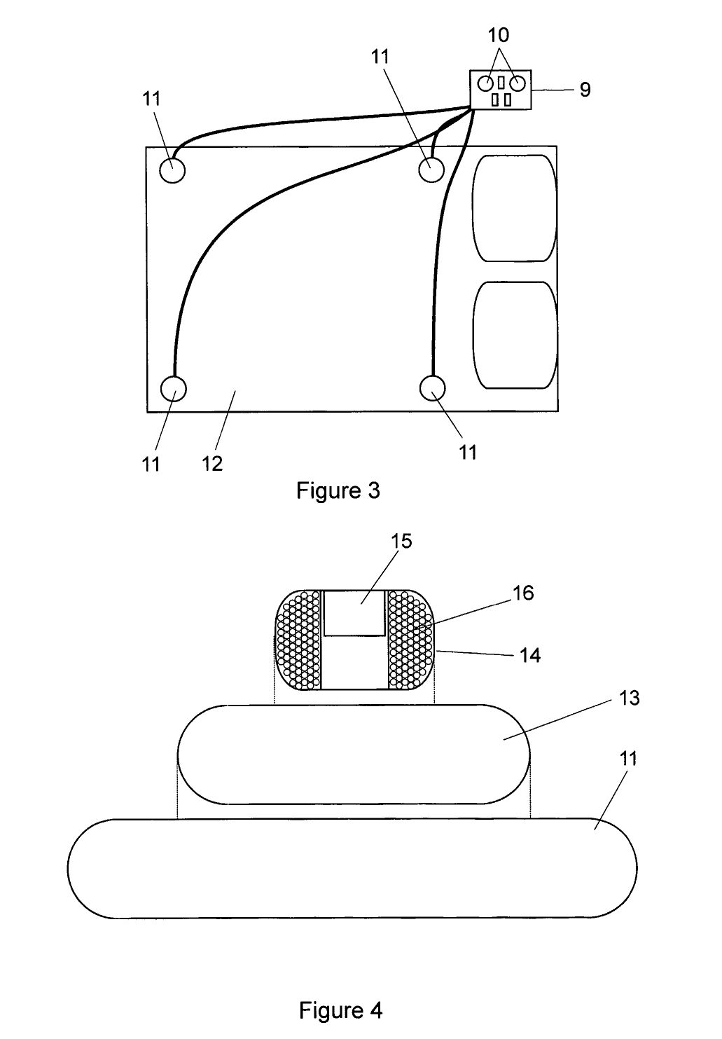

A control unit, indicated by numeral (9) in the FIG. 3, is adapted to supply electrical energy to each of the coils sequentially so that the magnetic field generated by each sequentially attracts the ball within the track thereby causing it to move around the track in continuous manner for so long as the electrical energy is supplied sequentially to the coils. The operation is very much along the lines of a linear induction motor.

Clearly, by providing suitable controls (10) on the control unit the speed or frequency with which the coils are energized and de-energized can be controlled rather easily using modern-day electronics that do not need to be further described herein. Suffice it to say that the speed can easily be made adjustable between something of the order of 5 to 20 revolutions per second to much higher speeds, as may be required.

As the ball rotates within the track it will create vibrations that are predominantly in the plane of the track. Nevertheless, in the usual case in which the track is orientated horizontally, the weight of the ball will indeed follow a circular path and cause a vertical component of vibration to be generated by virtue the weight of the ball being exerted on the mattress or the like in its constantly changing position along the circular path.

As shown in FIG. 3, a vibration generator assembly can comprise a plurality of vibration generators as described above and each of which is indicated generally by numeral (11). There are four such vibration generators illustrated in FIG. 3, but the actual number used in each assembly will vary according to requirements and size of, for example, a mattress (12) on which the assembly is to be used.

Irrespective of the number of vibration generators used, the speed of operation of each can be adjusted independently of the others and the interaction of the different vibrations set up by each of the vibration generators will form a movement somewhat akin to standing waves, as mentioned above. The location of the standing waves on the mattress will vary according to the interrelationship of the speeds of rotation of each of the vibration generators.

In order to further enhance the versatility of vibration generators according to the invention, and as illustrated in FIG. 4, a composite vibration generator unit may be provided that includes a vibration generator (11) as described above that receives within it, in coplanar and coaxial manner, a smaller diameter vibration generator (13) that conveniently clips within it. In this case, it will be understood, that in instances in which the two balls are located at radially identical positions and are rotated at the same speed, a maximum vibration effect will be achieved whilst if the two balls are located at diametrically opposite locations, a minimum vibration effect will be achieved. On the other hand, if the two balls are rotated at different speeds a surging of the severity of vibration between a maximum and minimum will result.

Still further, as indicated above, if additional transverse vibration is required, a central auxiliary vibration generator (14) can clip within a vibration generator, in the case illustrated in FIG. 4, the inner vibration generator (13). The auxiliary vibration generator (14) may have a simple magnetic element (15) therein that can be caused by coils (16) to oscillate in reciprocating manner in the direction of the axis of the track of the housing, in other words at right angles to the plane of the vibration generator itself. Utilising such an auxiliary vibration generator enables vibrations to be designed that are suitable for achieving any particular purpose.

It will therefore be understood that numerous variations may be made within the scope of this invention without departing from the scope hereof. In particular, it should be noted, that more than one magnetic element can be located within the same track and that, whilst the speed of the two magnetic elements will generally be limited to being the same, various effects can be achieved, in particular, as regards the severity of vibration generated at any particular speed. Indeed the presence of two magnetic elements within a single endless track could replace the effect of having a second vibration generator received within a first one as described with reference to FIG. 4.

Also, considerable flexibility exists as regards the control circuitry and in a preferred arrangement it may depend on performance in practice of the vibration generator. In particular, it is envisaged that it may be necessary to exercise electronic control over the speed of rotation of the magnetic element and, with this end in view, it may be necessary or desirable to monitor the rotation of the magnetic element within the track of the housing.

This may most easily be achieved utilising pick-up coils indicated by numeral (17) in FIGS. 1 and 2 that would sense passage of the magnetic element past them and feed back a signal to the control circuitry. The feedback could be employed by the circuitry to, for example, increase or decrease power in order to maintain a predetermined speed that may be dependent on the load applied to the vibration generator by virtue of its physical restraint, or otherwise. Still further, the control circuitry may include a control switch device located at the operation generator unit itself for energising the driving coils sequentially based on a single control signal received from the control circuitry. Such an arrangement would diminish the number of conductors required in a control cable such as that indicated by numeral (7) in FIG. 2.

1. A vibration generator comprising a housing, a weight movable relative to the housing for operatively imparting a vibratory movement to the housing, and means for imparting movement to the weight for causing said vibratory movement of the housing,
wherein the weight is a magnetic element that is freely movable along a track within the housing and wherein a plurality of electric coils are associated with the track for operative sequential energisation to create movement of the magnetic element within the track to impart a vibratory movement to the vibration generator.

2. A vibration generator as claimed in claim 1 in which the track is an endless track that follows a path selected from a circular and an elliptical path.

3. A vibration generator as claimed in claim 2 in which the coils are generally equally spaced along the track.

4. A vibration generator as claimed in claim 1 in which the coils are wound around the housing concentrically with the track therein at spaced positions along the track.

5. A vibration generator as claimed in claim 1 in which the track has a surface layer operatively engaged by the magnetic element,
wherein said surface layer has qualities that of sound absorption.

6. A vibration generator as claimed in claim 1 in which the magnetic element is spherical in shape and the track is of generally circular shape in cross-section.

7. A vibration generator as claimed in claim 1 in which the housing and coils are encased within an outer shell formed to permanently enclose the housing and coils.

8. A vibration generator as claimed in claim 1 in which the housing is sealed in a closed condition following evacuation of air and optional purging with a suitable gas.

9. A vibration generator as claimed in claim 2 in which an auxiliary vibration generator having a reciprocally movable weight therein is located in the centre of the vibration generator with the axis of movement of the reciprocally movable weight being at generally right angles to the plane of the track to thereby generate vibrations in two transverse directions.

10. A vibration generator composite unit comprising a vibration generator as claimed in claim 1 in which a second vibration generator is located coaxially therewith.

11. A vibration generator composite unit as claimed in claim 10 in which the vibration generators are of different diameters with a smaller one being received within a larger one in substantially coplanar relationship.

12. A vibration generator assembly comprising at least two vibration generators as claimed in claim 1 wherein the vibration generators are connected to a common control unit that operatively controls the operation of the electric coils associated with the tracks of the vibration generators and wherein the control unit is configured to cause the vibration generators to create interference waves consequent on interaction of the individual vibrations created by each vibration generator.

13. A vibration generator assembly comprising at least two vibration generator composite units as claimed in claim 11 wherein the composite units are connected to a common control unit that controls the operation of the electric coils associated with the tracks of the various vibration generators and wherein the control unit is configured to cause the vibration generators to create interference waves consequent on the interaction of the individual vibrations created by each vibration generator.
